(19) United States
(12) Patent Application Publication
(10) Pub. No.: US 2008/0206582 A1
(43) Pub. Date: Aug. 28, 2008

(54) Adhesive Composition

(76) Inventors: Werner Scholtyssek, Rehburg-Loccum (DE); Holger Brandt, Stadthagen (DE); Kai Robke, Ahnsen (DE); Ulf Walkling, Bruckeburg (DE)

Correspondence Address: HENRY M FEIEREISEN, LLC;HENRY M FEIEREISEN, 708 THIRD AVENUE, SUITE 1501, NEW YORK, NY, 10017, US

(21) Appl. No.: 10/563,081

(22) PCT Filed: Jun. 29, 2004
(86) PCT No.: PCT/EP2004/007036

§ 371 Date: Apr. 21, 2008

(30) Foreign Application Priority Data
Jun. 30, 2003 (DE) 10329594.1

(51) Int. Cl. B32B 27/30; C08L 29/04

(52) U.S. Cl. 428/522; 525/57

(57) ABSTRACT

The present invention refers to an adhesive composition in the form of watery dispersion with a polymer as the dispersoid, an ethylene unsaturated monomer and a first dispersing agent from a modified polyvinyl alcohol and at least a vinyl alcohol polymer as a further dispersing agent. The adhesive composition according to the invention has the advantage that it possesses good adhesion and flow properties and a surprisingly high water stability under an almost neutral pH value, wherein the disadvantages of an acidic adhesive composition, such as e.g. the discoloration of certain wood types, corrosion promoting properties and the premature crosslinking in the batch are avoided.

The invention refers to an adhesive, preferably a polyvinyl acetate adhesive in a watery dispersion claiming the priority of the German Patent Application 103 29 594.1 which is hereby incorporated by reference.

Polyvinyl acetate is an adhesive preferred in particular for use with wood due to its low production and processing cost and its environmental-friendly properties.

However, since polyvinyl acetate exhibits a lack of water and heat resistance it has been an object of the industry to provide polyvinyl acetate compositions with improved properties relative to the water stability and heat resistance. (Zhou, 1991; Lu, 1996; Chen, 1996; Comyn, 1996; Cai, 1997; Wang, 1999). To this end, especially co-polymerides with hydrophobic or cross-linked monomers and mixtures with other polymers were developed. Thus, highly water stable wood adhesives were developed utilizing polyvinyl acetate, with polyvinyl alcohol as protective colloid, as well as cross linked monomers, which satisfy the requirements for the stress groups D3 and D4 according to DIN EN 204. However, in practice, it has turns out, improvement of one of these properties oftentimes leads to problems relative to another property.

Partially hydrolyzed polyvinyl alcohols used as dispersing agents exhibit a lack in water stability. Even when using completely hydrolyzed polyvinyl alcohols, no satisfactory water stability is realized and additionally exhibits low storage stability and poor processing properties. To date, mixtures of these compounds have not led to any satisfactory results.

Finally, polyvinyl alcohols with a high degree of hydrolysis, at least 96 Mol % in modified form were utilized, in order to realize the desired water stability. The modified polyvinyl alcohol had a content of ethylene units from 2 to 9 Mol %. This adhesive composition was designed to render use of a cross-linking agent superfluous.

The adhesive utilizing the modified polyvinyl alcohol, while possessing a desirable water stability, exhibited however considerable disadvantages during the production cycle. Thus, the adhesive could not form a homogenous film; rather, it tended to form coagulates.

In an attempt to realize such a homogenous film, an emulsifier was used as an additive in order to render the more water resistant adhesive usable for industrial purposes. While the addition of the emulsifier enhanced the processing qualities, at the same time, it reduced the water stability considerably, so that any advantages in the adhesive were practically lost.

It is thus the object of the present invention to provide an adhesive composition having high water stability and improved rheological properties.

This object is realized with an adhesive in form of a preferably watery dispersion which includes as a dispersoid a polymer of an ethylene unsaturated monomer and a first dispersion agent from a modified polyvinyl alcohol with an ethylene unit content below 20 Mol %, preferably from 2 to 9 Mol %, especially preferred from 3 to 8 Mol %, and which includes polyvinyl alcohol as a further dispersion agent. The core of the invention is the addition of polyvinyl alcohol. Advantageously, the polyvinyl alcohol leads to considerably improvement of the rheological properties of the adhesive. The adhesive according to the present invention forms an homogenous adhesive film and exhibits no tendencies to form coagulates. Therefore, the adhesive according to the present invention is easily processed by machine, such that it can also be extensively used in industrial areas. Due to the improved rheological properties, the adhesive according to the invention is superior to the conventionally known adhesives, in particular, also regarding the fact that rheological properties, plasticity, elasticity and viscosity have gained in importance and are especially important with respect to dosing the adhesive, production of the adhesive layer and the description of the hardening process.

Surprisingly, the addition of the polyvinyl alcohol as an additional dispersion agent to the modified polyvinyl alcohol which imparts the high water stability, has led in no way to a loss in water stability.

As a result, the present invention rests on the insight, that what was assumed in the prior art (see e.g. EP 0699 697), namely that addition of a polyvinyl alcohol has a negative impact on the water stability and processability of the adhesive, is incorrect. In the combination of the present invention, no loss of water stability could be observed, but rather, according to the afore-stated, a distinct improvement of those properties considered important for processing of the adhesive, as for example also stability. This also applies when utilizing a completely hydrolyzed polyvinyl alcohol. As a consequence, despite the use of polyvinyl alcohol it is not necessary, to add cross-linking agents, such as for example isocyanate in order to retain water stability on a very high level.

As starting material for the polymer dispersoid, ethylene unsaturated monomers can be used. Examples of such monomers include olefins such as ethylene, propylene and isobutylene; halogenated olefins such as vinyl chloride or vinylene fluoride; acrylic acid esters such as for example acrylic acid, methylacrylate, ethylacrylate, methacrylic acid; methacrylic acid ester such as methylmetacrylate; dimethyl aminoethyl acrylate, and quaternary compounds thereof; acrylamide monomers; styrol monomers; N-vinylpyrrolidon; dienmonomers such as butadiene, isopropene and chloroprene; vinyl ester such as vinyl formiate, vinyl acetate, vinyl propionate and vinyl versatate. For example, those preferred examples as recited in DE 695 04 151 for the ethylene unsaturated monomer can be utilized either alone or in combination of two or more. Incorporated by reference is the subject matter disclosed of DE 695 04 151 with respect to the polymer dispersoid preferably utilized with the present invention.

The adhesive of the present invention is preferably free of copolymer as a dispersoid, which includes a primary hydroxyl group-containing ethylenic unsaturated monomer units, as described for example in DE 692 29 921. The use of these monomers has the disadvantage that especially under heat and UV radiation cross-linking can occur leading to the reduction of the adhesive properties and negatively impacting the ability to process the adhesive.

The dispersoid is preferably polyvinyl acetate. The amount relative to the dispersion can be preferably in the range from 40 to 60% by weight, especially preferred 45 to 55% by weight. The polyvinyl acetate has, for example a polymerization degree of 100 to 2500.

The modified polyvinyl alcohol according to the invention is preferably realized though hydrolysis of a co-polymer of vinyl ester and ethylene. Examples for the vinyl ester include vinyl formiate, vinyl acetate, vinyl propionate and vinyl pivalate, with vinyl acetate being preferred. The modified polyvinyl alcohol has preferably a hydrolysis degree of at least 95%.

A variety of copolymers of an ethylene unsaturated monomer can also be utilized as a modified polyvinyl alcohol, in so far as it does not impair the efficiency according to the invention. Examples of ethylene unsaturated monomers include acrylic acid, methacrylic acid, (water-free) phthalic acid (water-free) maleinic acid, (water-free) itaconic acid, acrylonitrile, methacrylonitrile, acrylamide, meth-acrylamide, trimethyl-(3 acrylamide-3 diethylpropyl) ammonium chloride, acrylamide-2-methyl-propane sulfonate and its sodium salts, ethylvinyl ether, butylvinyl ether, N-vinyl-pyrrolidon, vinyl chloride, vinyl bromide, vinyl fluoride, vinyldene chloride, vinylidene fluoride, tetrafluoroethylene, sodium vinylsulfonate and sodium arylsulfonate. Preferred are those which have properties as set forth in DE 695 04 151. The subject matter of that disclosure is thus incorporated herein by reference.

In accordance with the invention, it is preferred to use an ethylene vinyl alcohol-co-polymer as modified polyvinyl alcohol, which preferably has a polymerization degree from 100 to 8000, especially preferred from 350 to 3500, more especially preferred from 500 to 1200. With regard to the degree of hydrolization, it is preferred that the ethylene vinyl alcohol co-polymer has a hydrolysis degree form 88 to 100 Mol %, especially from 95 to 100 Mol %. Furthermore, it is preferred that the adhesive contains ethylene vinyl alcohol-copolymer in an amount from 1 to 3% by weight, especially 1.5 to 2,8% by weight relative to the dispersion.

The vinyl alcohols which are utilized in accordance with the invention preferably have a degree of polymerization from 1500 to 3000, especially from 2000 to 2500. With respect to the degree of hydrolysis, it is preferred that the polyalcohol polymers have a degree of hydrolysis from 81 to 100 Mol %, especially from 85 to 92 Mol %. With respect to amount utilized in the dispersion, it is preferred, that the dispersion contains from 0.6 to 2.5% by weight, especially 1.0 to 2% by weight vinyl alcohol polymers.

In accordance with an advantageous development, several polyvinyl alcohols can be utilized as dispersion agents. A preferred variation is defined in claim 12.

The adhesive composition according to the invention, in addition to the already listed components, can also include further additives which are conventionally used for adhesives. These can be combined as desired, also in order to realize a precise adjustment relative to characteristics such as drying and setting, viscosity and film forming properties. Examples for such components are organic solvents, water soluble polymers, such as starches, modified starches, oxidized starches, methyl celluloses, carboxylmethyl celluloses and co-polymers of maleic acid anhydride and methyl vinyl ether, as well as heat-hardenable resins, which are commonly used as adhesives, surfactants, defoaming agents and/or those agents promoting filmforming. Furthermore, additional filler material such a clay, kaolin, talcum, calcium carbonate and wood dust, fillers, reaction promoters, pigments, dispersion agents, antifreeze, preservation agents and rust protectors can be added in accordance with desire or requirements.

The adhesive in accordance with the invention is marked by high water stability, good processing properties by forming a homogenous film as well as an extraordinarily good adhesion to various materials. Furthermore, the adhesive is highly compatible with other systems; it is fully compatible with respect to materials such as fillers, and exhibits water and storage stability. Thus, the adhesive can be used for gluing the most diverse materials, including also wood, veneer, plastics, non-woven fiber material and foils.

The adhesive composition is especially preferred for use as wood glue. Furthermore, the adhesive according to the invention, due to its special flow properties can be produced and processed in a faster way. It is thus generally useful for stress groups D1 to D4. In order to fulfill the requirements for stress group D4, it is advantageous to add an isocyanate hardener. The hardener is added in an amount of about from 1 to 10% relative to the basic dispersion.

In accordance with a further advantageous development, the dispersion has a pH value from 5.5 to 7.5, preferably from 6.2 to 6.9. The pH value is preferably adjusted with sodium carbonate.

The “neutral” pH value according to the invention is in particular advantageous as compared to the conventionally known adhesives. Thus, for example, with the conventional adhesives, oftentimes the problem of discoloration of the wood occurs when applying the adhesive. This is in particular a problem when gluing substrates of lesser material thickness, such as for example when gluing veneers. Reason for the frequently occurring reddish discoloration in connection with certain types of woods, such as for example beech, maple or black cherry, among others, are reactions between the conventionally known acidic adhesive systems and agents in the wood. These reactions become more visible when less material thickness is present. Based on the fact that in the last few years, due to cost efficiency concerns, thickness in material has been reduced, for example in veneers, such that this problem is now especially relevant. These discolorations result in higher cost due to failed merchandise and consumer complaints. The adhesive according to the invention solves this problem through choice of the “neutral” pH value according to the invention, as compared to the pH values of the conventional adhesives.

A further advantage of the pH-value realized in accordance with the invention. Is the distinctly reduced corrosive effect of the system as compared to the conventional acidic systems known in the prior art. The strain on pipes, pumps and tank containers are substantially reduced by a neutral pH-value.

Furthermore, in the adhesives of the prior art that are adjusted in the acidic range, oftentimes premature crosslinking is taking place in a batch which results in an unintended rise in viscosity. Such crosslinking is disadvantageously accompanied by an undesirable formation of formaldehyde. In addition, the adhesive systems adjusted in the acidic range reacts sensitively to exposure of sun rays and heat and must be protected from the effects of these. No such disadvantages are recorded with the adhesive having a “neutral” pH-value according to the invention. On the basis of the high water stability of the adhesive according to the invention, the pH value can be raised without loss of water stability. This is not the case with the known systems according to the prior art; they require a pH-value of about 3, otherwise, the required water stabilities are not realized.

Thus, the adhesive according to the invention is suitable for gluing various building components of different materials. Following are several examples.

In view of the fact that the adhesive according to the invention is especially suitable as wood glue, a wooden building component can be for example assembled from several layers, whereby the layers are glued together with the adhesive according to the invention. This is particularly advantageous if one of the layers of the wooden building component is veneer. It is further possible to carry out the surface bonding, advantageously on a hard laminate board (CPL) or a high pressure laminate board (HPL). Also, adhesive bonding can be carried out on solid wood.

It is also possible to glue together several layers of plastic-or non-woven fabric.

In accordance with a further embodiment, several plastic layers can be glued together, whereby the adhesive bonding may be thermal lamination (décor finish foil). The layers can also be, for example, suitably primed and corona-charged or also non pre-treated poly propylene sheeting.

Also, a building component consisting of several layers can be fabricated from highly compressed fiber boards (HDF) and aluminum.

The adhesive bonding can for example be carried out as a high frequency adhesive bonding.

Following is an example of an embodiment according to the invention.

5-35 g of a water soluble ethylene co-polymer and

10-50 g polyvinyl alcohol are stirred into

50-500 g water and dissolved under heat. The temperature of the solution is adjusted to 74° C. After adding

0.2-50 g emulsifier and

0.1-0.5 g a commercially available defoaming agent,

0.2-0.5 g a water soluble polymerization initiator and

30-60 g vinyl acetate (if suitable with one or more co-monomers) are added.
After start of polymerization, which is noticeable by the starting exothermal reaction, during a period of 3 to 6 hrs

380g-460 g vinyl acetate (if suitable with one or more co-monomers) are added.
In order to initiate the post reaction, added to the mixture is again

0.05-0.3g of a water soluble polymerization initiator.
After the post-reaction ended, the dispersion is adjusted with alkali to pH 6.5-6.9 and cooled to room temperature.
Further admixed are

1-3 g of a commercially available preserving agent, and

0.1-20 g of a film forming promoting agent.

The adhesive consistency of the dispersion according to the invention was measured according to EN 204/205 and resulted in the D3 value of 2.6 N/mm^{2.}

The rheological properties were excellent. Comparisonwise, the dispersions according to the prior art were produced with only the use of a water soluble ethylene co-polymer. They showed very poor flow properties and exhibited raised levels of coagulates. Since that adhesive was not suitable for industrial processing, their adhesion property was not determined. In order to improve the rheological properties, commercially available emulsifiers were added. Thereby, the rheological properties were improved and the coagulation portion reduced, however, the water stability was worsened. The adhesive strength of these processable dispersions was determined according to EN 204/205 and resulted in values below 2.0 N/mm², which did not fulfill the requirements.

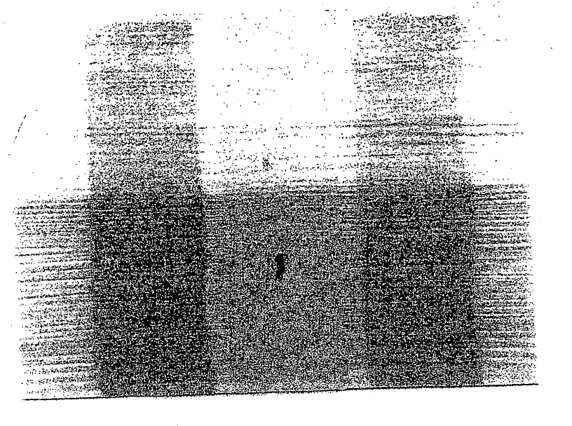

FIG. 1 shows a photography in which the positive properties of the adhesive according to the invention are illustrated in comparison with 2 commercially available D3 wood glues. The adhesive according to the invention, which fulfills the requirements for stress group D3 is spread in the central area showing a “neutral” pH-value of about 6.5-6.9. To the left and to the right, the comparative glues are spread out. They show a relatively strong acidic pH value in the range of 3 to 3.5 due to the crosslinking mechanism. As seen from the Figure, the “acidic” wood adhesives, upon contact with the wood show a distinct reddish discoloration. This is in particular seen with woods containing tannic acid or other content-rich woods types. This leads especially with veneers, and again here with expensive tropical wood veneers, to the disadvantages as afore-described. In the centrally applied wood adhesive, this critical discoloration is advantageously absent.

1-14. (canceled)

15. An adhesive in form of preferably a watery dispersion, comprising:
a dispersoid of a polymer of an ethylenic unsaturated monomer,
a first dispersing agent from a polyvinyl alcohol modified by ethylene units with an ethylene unit content below 20 Mol %,
a further dispersing agent, which is a vinyl alcohol polymer, and wherein the dispersion has a pH from 5.5 to 7.5.

16. The adhesive of claim 15, wherein the dispersoid is polyvinyl acetate.

17. The adhesive of claim 16, wherein the polyvinyl acetate has a degree of polymerization from 100 to 2500.

18. The adhesive composition of claim 16, wherein the polyvinyl acetate is present in an amount from 40 to 60% by weight, relative to the dispersion.

19. The adhesive composition of claim 15, wherein the modified polyvinyl alcohol is an ethylene vinyl alcohol-co-polymer.

20. The adhesive of claim 19, wherein the ethylene vinyl alcohol-co-polymer has a degree of polymerization from 100 to 8000.

21. The adhesive of claim 19, wherein the ethylene vinyl alcohol-co-polymer has a degree of hydrolysis from 88 to 100 Mol %.

22. The adhesive of claim 19, wherein the ethylene vinyl alcohol-co-polymer is present in an amount from 1 to 3% by weight, relative to the dispersion.

23. The adhesive of claim 15, wherein at least one of the vinyl alcohol polymer has a degree of polymerization from 1500 to 3000.

24. The adhesive of claim 19, wherein at least one of the vinyl alcohol polymer has a degree of hydrolysis from 81 to 100 Mol %.

25. The adhesive of claim 15, wherein at least one of the vinyl alcohol polymer is present in an amount from 0.6 to 2.5% by weight, relative to the dispersion.

26. The adhesive of claim 15, wherein the vinyl alcohol polymer comprises a first partially saponified polymer with a polymerization degree from 1500 to 3000, a degree of hydrolysis from 88 to 92 Mol % and a viscosity from 15 to 30 mPa. sec., each in watery solution, in an amount from 0.1 to 1.50 Mol % by weight, relative to the dispersion, and
a further partially saponified polymer with a polymerization and hydrolysis degree like the first partially saponified polymer and having a viscosity from 30 to 50 mPa. sec, each in a 4% watery solution, in an amount from 0.5 to 1.5% by weight, relative to the dispersion.

27. A building component comprising several layers, wherein the layers are glued together with the adhesive of claim 15.
